(19) United States
(12) Patent Application Publication
(10) Pub. No.: US 2025/0248415 A1
(43) Pub. Date: Aug. 7, 2025

(54) FOOD PRODUCT COMPRISING POWDERED FAT

(71) Applicant: CARGILL, INCORPORATED, Wayzata, MN (US)

(72) Inventors: Tatiana Yasuoka BRADASCHIA, São Paulo (BR); Silmara Franco DE GODOY, Campinas (BR); Camila Cordeiro MANDU, Rotterdam (NL); Ana Carolina MARCUCCI, São Paulo (BR); Serpil METIN, Plymouth, MN (US); Rodolfo Lázaro Soares VIRIATO, São Paulo (BR); Fernanda ZACCARELLI DAVOLI, Plymouth, MN (US)

(21) Appl. No.: 18/856,217

(22) PCT Filed: Apr. 13, 2023
(86) PCT No.: PCT/US2023/018509

§ 371 Date: Oct. 11, 2024

Related U.S. Application Data
(60) Provisional application No. 63/331,192, filed on Apr. 14, 2022.
(60) Provisional application No. 63/331,196, filed on Apr. 14, 2022.

(51) Int. Cl. A23D 9/00; A21D 13/80; A23G 3/40

(52) U.S. Cl. CPC A23D 9/00; A21D 13/80; A23G 3/40

(57) ABSTRACT

Provided herein is a food product comprising a powdered fat that is consisting of 20 wt. % to about 100 wt. % of a hard fraction and up to 80 wt % of a soft fraction wherein the hard fraction is derived from fats or fat blends that are solid at 20° C. at atmospheric pressure and wherein the soft fraction is derived from oils or oil blends that are liquid at 20° C. at atmospheric pressure, and wherein the powdered fat is not derived from palm oil or palm kernel oil, the food product is a biscuit filling, wafer filling, pie cookie filling, cracker filling or cookie filling. It relates to the use of such a powdered fat to reduce the saturated fatty acid content of a food product.

### CROSS-REFERENCE TO RELATED APPLICATIONS

This application claims the benefit of U.S. Provisional Application No. 63/331,196, filed Apr. 14, 2022, U.S. Provisional Application No. 63/331,192, filed Apr. 14, 2022, each of which are incorporated by reference herein in its entirety.

### BACKGROUND

Current practice to produce a fat based bakery filling, a cookie, biscuit or wafer filling and/or topping and/or coating and apply it to the cookie, biscuit or wafer is labor intense. It is a high consuming energy process. The filling and/or topping has to be made and mixed under warm temperature, then energy is necessary to cool down the cookie, then the warm filling has to be crystallized (cool down) after applied on the cookie. It is also a time-consuming process as it requires time for the filling to solidify under controlled temperature (cooling tunnel) before the product can be packaged.

As the filling has to solidify, the fat used for filling manufacturing has to have considerable amount of saturated fat which provides structure to the filling. It has been a challenging for the bakery industry to produce a non-palm and/or lower saturated fat filling keeping the targeted structure, creaminess and functionality

### SUMMARY

Provided herein is a food product comprising a powdered fat, and uses thereof, which was surprisingly found to allow making a filling which has lower amounts of saturated fatty acids and more unsaturated fats, thus fulfilling the dietary guidelines for more healthy fats, by the addition of higher amounts of liquid oil when compared to the traditional cookie filling. At the same time, desired filling structure, creaminess and functionality was kept.

Further advantages of the fillings and/or topping and/or coating are: lecithin use can be minimized or eliminated, less oil leaking or migration, and cost competitive.

It relates to food product comprising a powdered fat that is consisting of 20 wt. % to about 100 wt. % of a hard fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure, and wherein the powdered fat is not derived from palm oil or palm kernel oil.

Finally, it relates to the use of a powdered fat that is consisting of 20 wt. % to about 100 wt. % of a hard fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure, and wherein the powdered fat is not derived from palm oil or palm kernel oil to reduce the saturated fatty acid content of a food product.

### DESCRIPTION OF THE INVENTION

Fat is the second most important ingredient in fat-based bakery fillings in terms of amount and it is key to define filling texture, creaminess and functionality. Conventional fillings, coating, toppings contain shortenings with high amounts of saturated fats. For instance, conventional fillings may be based upon palm oil and palm oil is containing 50% of saturated fatty acids (SAFA). Existing fat based fillings can contain from 20 to 60% fat.

It is well known that excessive consumption of saturated fats can lead to cardiovascular problems. Therefore, there is a drive to reduce the amount of saturated fat in the diet.

### Definitions

For the purposes of clarity and a concise description, features can be described herein as part of the same or separate aspects; however, it will be appreciated that the scope of the invention may include aspects having combinations of all or some of the features described.

As used herein, the indefinite articles “a”, “an” and “the” should be understood to include plural reference unless the context clearly indicates otherwise. Thus, for example, reference to “an inhibitor” refers to one or more agents with the ability to inhibit a target molecule, and reference to “the method” includes reference to equivalent steps and methods known to those skilled in the art, and so forth.

The phrase “and/or,” as used herein, should be understood to mean “either or both” of the elements so conjoined, e.g., elements that are conjunctively present in some cases and disjunctively present in other cases.

When separating a listing of items, “and/or” or “or” shall be interpreted as being inclusive, e.g., the inclusion of at least one, but also including more than one, of a number of items, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein, the term “about” means plus or minus 10% of the indicated value. For example, about 100 means from 90 to 110.

Where a range of values is provided, it is understood that each intervening value, between the upper and lower limit of that range and any other stated or intervening value in that stated range is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either both of those included limits are also included in the invention.

As used herein, the terms “including”, “includes”, “having”, “has”, or “with” are intended to be inclusive similar to the term “comprising.”

The terms “comprises,” “comprising,” and the like can have the meaning ascribed to them in U.S. Patent Law and can mean “includes,” “including” and the like. As used herein, “including” or “includes” or the like means including, without limitation.

Unless otherwise defined, all technical and scientific terms used herein have the same meaning as commonly understood by one of ordinary skill in the art to which the methods and compositions of matter belong. Although methods and materials similar or equivalent to those described herein can be used in the practice or testing of the methods and compositions of matter, suitable methods and materials are described below. In addition, the materials, methods, and examples are illustrative only and not intended to be limiting. All publications, patent applications, patents, and other references mentioned herein are incorporated by reference in their entirety.

### Food Product

The present invention relates to a food product comprising a powdered fat that is consisting of 20 wt. % to about 100 wt. % of a hard fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure, and wherein the powdered fat is not derived from palm oil or palm kernel oil.

The food product is baked goods, baked goods that are filled and/or topped and/or coated or with added inclusions, pie, bread, cake, donut, waffles, confectionery goods, confectionery filling, biscuits, dough product, filling, topping, coating, icing, frosting, cookie filling, biscuit filling, wafer filling, sandwich cookies, pie cookies, extruded cookies, thumbprint cookies, Hamentaschen cookies, whoopie cookies, linzer cookies, macarons, chocolate spread, nut butter, toffee, caramel, compound chocolate, compound coatings, ice-cream, microwaved popcorn, meat alternative, or milk or dairy fat replacer, pie crust, cake, pizza crust, cookie, biscuit, snacks, cereals, pasta, powdered food as powder instant soup, instant mashed potato, powder savory blends, powder cake mix, powder cheese bread, popcorn, crackers, savory bakery goods, bouillon.

In one aspect of the invention, the food product is a biscuit filling, wafer filling, pie cookie filling, cracker filling or cookie filling.

The food product according to the present invention has a free liquid oil volume of less than 3%, measured with X-ray computed tomography, and free liquid oil volume is the percentage of liquid oil which is not held by the solid structure of the fat. It allows the quantification of the free liquid oil percentage in a pre-defined volume of filling. Free liquid oil is the percentage of liquid oil which is not held (entrapped) by the crystal structure under the conditions studied as described in the examples. In comparison, a filling made with palm oil has a free liquid oil volume of 5.1%.

In one aspect of the invention, the food product selected from biscuit filling, wafer filling, pie cookie filling, cracker filling or cookie filling has a free liquid oil volume of 1.0% to 2.5%, or 1.5% to 2.3%.

The SAFA content of the food product is reduced with at least 20%, up to 65%, preferably from 25 to 55%.

### Powdered Fat

The powdered fat is consisting of from 20 to 100 wt % of a hard fat fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure.

The powdered fat described herein is typically porous in structure and in powder form. The powdered fat particles are neat, and typically are spherical with open spongy structure. In other aspect the powdered fat can be seen as a foam like structure.

Generally, the powdered fat used in the present invention is made as described in our earlier application (WO2020198585A1) by using a supercritical CO2 technology. Micronization is about making small particles of fat. Micronization of different fats is considered using different techniques. In general, micronization is used to create free flowing powders to encapsulate unstable oils or oil-soluble ingredients, primarily for nutritional effect.

The powdered fat of the present invention is made using a supercritical CO2 technology. The fat is either melted at a temperature ranging from at least about 5 to about 25 degrees above the melting temperature of the fat, and in some aspects at least about 5 to about 20 degrees above the melting temperature of the fat, and in other aspects at least about 5 to about 15 degrees above the melting temperature of the fat, and in yet other aspects at least about 5 to about 10 degrees above the melting temperature of the fat. The fat is then saturated with CO2 to obtain a mixture and such mixture is pressured at the CO2 triple point to achieve supercritical CO2. This causes the fat to be solubilized. This is then sprayed (atomized) causing the so-called crystallization, solidification, micronizing, atomization of the fat as the CO2 evaporates. This creates the powdered fat. This is typically done in a batch or semi-continuous process and the temperature is adjusted to that which is lower than the melting point of the fat to ensure the fat is in solid, powdered form.

In some aspects, the powdered fat comprises from 20 to 100 wt % including 85%- 99 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, 97 wt %, 98 wt % or 99 wt %, of a hard fraction, and up to 80 wt %, including 5-75 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70, wt %, 75 wt %, 76 wt %, 16 wt %, 17 wt %, 18 wt % or 79 wt %, of the soft fraction.

The powdered fat is having a density ranging from 0.04 to 0.70 g/mL at room temperature, in some aspects from about 0.05 g/mL to about 0.50 g/mL at room temperature, and in some aspects has a density ranging from 0.10 g/mL to about 0.40 g/mL at room temperature.

It shall be understood that reference to “density” herein means bulk density (also referenced as apparent density or volumetric density), which is a property of powders, granules, and other divided solids. It is defined as the mass of many particles divided by the total volume.

The powdered fat of the present invention is having a particle size ranging from 0.01 to 200.0 μm, preferably from 1 to 150 μm (microns).

The powdered fat also has a particle size distribution wherein at least 50%, in some aspects at least 60%, in some aspects of least 70%, in some aspects at least 80%, and in some aspects at least 90% (depending on the type of fat) of the particles have a particle size ranging from 0.01 to 200 microns, including 1-190 microns, 2-180 microns, 5-170 microns, 8-160 microns, 10-150 microns.

### Hard Fat/Fat Fraction

Hard fat/fat fraction is derived from fats or fat blends that are solid at 20° C., at atmospheric pressure.

The hard fraction is a single fat or a blend of fats derived from sunflower oil, corn oil, soybean oil, canola oil, rapeseed oil, cottonseed oil, rice bran oil, safflower oil, linseed oil, flaxseed oil, peanut oil, olive oil, tall oil, licuri oil, macadamia nut oil, its high oleic version its high stearic versions, shea butter, coconut oil, mango kernel oil, illipe oil, babassu oil, pequi oil, tallow, allanblackia oil, cocoa butter, nut oil, bacuri fat, cupuassu fat, ucuuba butter, macauba oil, macauba kernel oil, animal fat, dairy fat, and their fractions and their fully or partially hydrogenated and/or chemically or enzymatically interesterified versions, and combinations of two or more thereof.

### Soft Fraction

Soft fraction is derived from oils or oil blends that are liquid at 20° C. at atmospheric pressure.

The soft fraction is derived from soybean oil, sunflower oil, rapeseed oil, canola oil, corn oil, cottonseed oil, rice bran oil, safflower oil, linseed oil, flaxseed oil, peanut oil, olive oil, tall oil, licuri oil, macadamia nut oil, its high oleic versions, its high stearic versions, its partially hydrogenated, chemically interesterified, enzymatically interesterified versions and combinations of two or more thereof.

### Liquid Oil

The present invention relates to a food product wherein the food product is comprising a liquid oil or oil blends that are liquid at 20° C., at atmospheric pressure.

The liquid oil is derived from soybean oil, sunflower oil, rapeseed oil, canola oil, corn oil, cottonseed oil, rice bran oil, safflower oil, linseed oil, flaxseed oil, peanut oil, olive oil, tall oil, licuri oil, macadamia nut oil, its high oleic versions, its high stearic versions, its partially hydrogenated, chemically interesterified, enzymatically interesterified versions and combinations of two or more thereof.

### Food Ingredient Other than Powdered Fat or Liquid Oil

Food ingredients can be in powder, paste or liquid form. Food ingredients other than liquid oil can comprise additives, flavorings, colorings, thickening agents, sweetener-based ingredients (a substance used to sweeten food or drink, such as sugar, honey, glucose syrups, fructose syrups, maple syrup, agave nectar or other non-sugar sweeteners, such as saccharin, aspartame, cyclamates, steviol, and thaumatin and the like).

Thickening agents may comprise gums, such as, but not limited to, carrageenan, konjac gum, lotus bean gum, guar gum, alginate, pectin, gelatin or xanthan gum, vegetable fibers, maltodextrins, starches from various botanical sources, such as potato starch or maize starch, being in form of native starch, physically or chemically modified starch, or a mixture of two or more thereof.

Other ingredients suitable for the food product of interest may be added as well, such as flour, vegetable and/or animal proteins, milk solids, fruit powders, dried fruit, nuts, spices, seasonings, acids such as citric acid, chocolate, salt, cocoa liquor, cocoa powder, antioxidants and the like.

Food ingredients may also comprise surface active material and/or emulsifiers. They can include food grade emulsifiers, including, but not limited to, lecithins, monoglycerides, diglycerides, polysorbates, propylene glycol esters, polyglycerol esters, acetic acid esters of mono and diglycerides, citric acid esters of mono and diglyceride, sucrose esters of fatty acid, sorbitan esters, polyglycerol polyricinoleate or lactic acid esters of mono and diglyceride or its combinations of two or more thereof.

### Uses of Powdered Fat in Fillings, Toppings and Coatings

The present invention relates to the use of a powdered fat that is consisting of 20 wt. % to about 100 wt. % of a hard fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure, and wherein the powdered fat is not derived from palm oil or palm kernel oil to reduce the saturated fatty acid content of a food product.

In one aspect of the invention, it relates to the use wherein the food product is a biscuit filling, wafer filling, pie cookie filling, cracker filling or cookie filling.

It further relates to the use wherein the free liquid oil volume of the food product is less than 3%, measured with X-ray computed tomography, and free liquid oil volume is the percentage of liquid oil which is not held by the solid structure of the fat.

### Process for Preparing the Fillings, Toppings and Coatings

A suitable process for making the food product of the present invention is comprising the following steps:
a. mixing a powdered fat with one or more other food ingredients other than liquid oil, and/or fat composition different from liquid oil,
b. applying shear,
c. optionally adding liquid oil,
d. applying shear

Another suitable process for making a biscuit filling, wafer filling, pie cookie filling, cracker filling or cookie filling is comprising the following steps:
a) mixing of food ingredients other than fat and liquid oil, and/or optionally a fat composition and/or liquid oil
b) applying shear to mixture of step a); and
c) add optionally other food ingredients other than liquid oil to a) and apply shear
d) add a powdered fat to c) and apply shear
e) Repeat c) as needed

### Clauses

1. A food product comprising a powdered fat that is consisting of 20 wt. % to about 100 wt. % of a hard fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure, and wherein the powdered fat is not derived from palm oil or palm kernel oil.
2. The food product according to clause 1, wherein the food product is baked goods, baked goods that are filled and/or topped and/or coated or with added inclusions, pie, bread, cake, donut, waffles, confectionery goods, confectionery filling, biscuits, dough product, filling, topping, coating, icing, frosting, cookie filling, biscuit filling, wafer filling, sandwich cookies, pie cookies, extruded cookies, thumbprint cookies, Hamentaschen cookies, whoopie cookies, linzer cookies, macarons, chocolate spread, nut butter, toffee, caramel, compound chocolate, compound coatings, ice-cream, microwaved popcorn, meat alternative, or milk or dairy fat replacer, pie crust, cake, pizza crust, cookie, biscuit, snacks, cereals, pasta, powdered food as powder instant soup, instant mashed potato, powder savory blends, powder cake mix, powder cheese bread, popcorn, crackers, savory bakery goods, bouillon.
3. The food product according to clause 1 wherein the food product is a biscuit filling, wafer filling, pie cookie filling, cracker filling or cookie filling.
4. The food product according to any one of clauses 1 to 3 wherein the food product is comprising a liquid oil or oil blends that are liquid at 20° C., at atmospheric pressure.
5. The food product according to any one of clauses 1 to 4 wherein the hard fraction of the powdered fat is derived from shea butter, coconut oil, mango kernel oil, illipe oil, babassu oil, pequi oil, tallow, allanblackia oil, cocoa butter, nut oil, bacuri fat, cupuassu fat, ucuuba butter, macauba oil, macauba kernel oil, animal fat, dairy fat, and their stearin fractions and their fully or partially hydrogenated and/or chemically or enzymatically interesterified versions, the fully or partially hydrogenated oils and/or chemically or enzymatically interesterified fats derived from sunflower oil, corn oil, soybean oil, canola oil, rapeseed oil, cottonseed oil, rice bran oil, safflower oil, linseed oil, flaxseed oil, peanut oil, olive oil, tall oil, licuri oil, macadamia nut oil, its high oleic version its high stearic versions and combinations of two or more thereof.
6. The food product according to any one of clauses 1 to 5 wherein the hard fraction is selected from the group consisting of fully or partially hydrogenated oils, chemically or enzymatically interesterified fats derived from sunflower oil, corn oil, soybean oil, canola oil, rapeseed oil, cottonseed oil, rice bran oil, safflower oil, linseed oil, flaxseed oil, and combinations of two or more thereof.
7. The food product according to any one of clauses 1 to 6 wherein the hard fraction is selected form the group consisting of fully or partially hydrogenated oils derived from sunflower oil, corn oil, soybean oil, canola oil, rapeseed oil, cottonseed oil, rice bran oil, safflower oil, linseed oil, flaxseed oil, and combinations of two or more thereof.
8. The food product according to any one of clauses 1 to 7 wherein the liquid oil of the food product and/or the soft fraction of the powdered fat is derived from soybean oil, sunflower oil, rapeseed oil, canola oil, palm olein, palm super olein, corn oil, cottonseed oil, rice bran oil, safflower oil, linseed oil, flaxseed oil, peanut oil, olive oil, tall oil, licuri oil, macadamia nut oil, its high oleic versions, its high stearic versions, its partially hydrogenated, chemically interesterified, enzymatically interesterified versions and combinations of two or more thereof.
9. The food product according to any one of clauses 1 to 8 wherein the liquid oil of the food product and/or the soft fraction of the powdered fat is derived from soybean oil, sunflower oil, rapeseed oil, canola oil, corn oil, cottonseed oil, rice bran oil, safflower oil, linseed oil, flaxseed oil, and combinations of two or more thereof.
10. The food product according to any one of clauses Ito 9 wherein the powdered fat is having a density ranging from 0.04 to 0.7 g/ml.
11. The food product according to any one of clauses 1 to 10 wherein the powdered fat is having a particle size ranging from 0.01 to 200.0 μm.
12. The food product according to any one of clauses 1 to 11 wherein the powdered fat is having a particle size ranging from 1.0 to 150.0 μm.
13. The food product according to any one of clauses 1 to 12 wherein the food product is comprising at least one surface active material and/or emulsifier selected from the group consisting of propylene glycol esters, polyglycerol esters, lecithins, monoglycerides, diglycerides, polysorbates, lactic acid esters of monoglycerides, lactic acid esters of diglycerides, acetic acid esters of monoglycerides acetic acid esters of diglycerides, citric acid esters of monoglycerides, citric acid esters of diglycerides, sucrose esters of fatty acids, sorbitan esters, polyricinoleate and combinations of two or more thereof.
14. The food product according to any one of clauses 1 to 13, wherein the food product comprises from 40% to 99.9% a food ingredient other than powdered fat and/or liquid oil.
15. The food product according to any one of clauses 1 to 14, wherein the food product comprises from 55% to 70% a food ingredient other than powdered fat and/or liquid oil.
16. The food product according to any one of clauses 1 to 15 wherein the food product has a free liquid oil volume of less than 3%, measured with X-ray computed tomography, and free liquid oil volume is the percentage of liquid oil which is not held by the solid structure of the fat.
17. Use of a powdered fat that is consisting of 20 wt. % to about 100 wt. % of a hard fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure, and wherein the powdered fat is not derived from palm oil or palm kernel oil to reduce the saturated fatty acid content of a food product.
18. The use according to clause 17 wherein the food product is a biscuit filling, wafer filling, pie cookie filling, cracker filling or cookie filling.
19. The use according to clause 17 or 18 wherein the free liquid oil volume of the food product is less than 3%, measured with X-ray computed tomography, and free liquid oil volume is the percentage of liquid oil which is not held by the solid structure of the fat.
20. A powdered fat that is consisting of 20 wt. % to about 100 wt. % of a hard fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure, and wherein the powdered fat is not derived from palm oil or palm kernel oil to reduce the saturated fatty acid content of a food product.
21. The powdered fat according to clause 20 wherein the hard fraction of the powdered fat is derived from shea butter, coconut oil, mango kernel oil, illipe oil, babassu oil, pequi oil, tallow, allanblackia oil, cocoa butter, nut oil, bacuri fat, cupuassu fat, ucuuba butter, macauba oil, macauba kernel oil, animal fat, dairy fat, and their stearin fractions and their fully or partially hydrogenated and/or chemically or enzymatically interesterified versions, the fully or partially hydrogenated oils and/or chemically or enzymatically interesterified fats derived from sunflower oil, corn oil, soybean oil, canola oil, rapeseed oil, cottonseed oil, rice bran oil, safflower oil, linseed oil, flaxseed oil, peanut oil, olive oil, tall oil, licuri oil, macadamia nut oil, its high oleic version its high stearic versions and combinations of two or more thereof.
22. The powdered fat according to any one of clauses 20 to 21 wherein the hard fraction is selected from the group consisting of fully or partially hydrogenated oils, chemically or enzymatically interesterified fats derived from sunflower oil, corn oil, soybean oil, canola oil, rapeseed oil, cottonseed oil, rice bran oil, safflower oil, linseed oil, flaxseed oil, and combinations of two or more thereof.
23. The powdered fat according to any one of clauses 20 to 22 wherein the hard fraction is selected form the group consisting of fully or partially hydrogenated oils derived from sunflower oil, corn oil, soybean oil, canola oil, rapeseed oil, cottonseed oil, rice bran oil, safflower oil, linseed oil, flaxseed oil, and combinations of two or more thereof.
24. The powdered fat according to any one of clauses 20 to 23 wherein the liquid oil of the food product and/or the soft fraction of the powdered fat is derived from soybean oil, sunflower oil, rapeseed oil, canola oil, corn oil, cottonseed oil, rice bran oil, safflower oil, linseed oil, flaxseed oil, peanut oil, olive oil, tall oil, licuri oil, macadamia nut oil, its high oleic versions, its high stearic versions, its partially hydrogenated, chemically interesterified, enzymatically interesterified versions and combinations of two or more thereof.
25. The powdered fat according to any one of clauses 20 to 24 wherein the liquid oil of the food product and/or the soft fraction of the powdered fat is derived from soybean oil, sunflower oil, rapeseed oil, canola oil, corn oil, cottonseed oil, rice bran oil, safflower oil, linseed oil, flaxseed oil, and combinations of two or more thereof.
26. The powdered fat according to any one of clauses 20 to 25 wherein the powdered fat is having a density ranging from 0.04 to 0.7 g/ml.
27. The powdered fat according to any one of clauses 20 to 26 wherein the powdered fat is having a particle size ranging from 0.01 to 200.0 μm.
28. The powdered fat according to any one of clauses 20 to 27 wherein the powdered fat is having a particle size ranging from 1.0 to 150.0 μm.

The following is provided for exemplification purposes only and is not intended to limit the scope of the invention described in broad terms above.

### EXAMPLES

### Analysis methods

### Bulk Density of Powdered Fat.

The bulk density (β) of the particles was determined using the tap method (Gudeman, Yang, and Ciftci 2019). Samples were filled into a 25 mL graduated cylinder and tapped slightly to avoid excess air between the particles. Then, the weight of the samples was recorded. The bulk density of the particles was calculated as: β=m/V (1) where, β is bulk density, m is weight of the sample, and Vis volume of the sample.

### Particle Size/Particle Size Distribution

The particle size and size distribution of the samples were determined by laser diffraction method using a Mastersizer 3000 (Malvern Instruments Ltd., Worcestershire, UK). Samples (30 mg) were dispersed in 3% (w/w) polyoxyethylene sorbitan monooleate (Tween 80) in water and sonicated in an ultrasonic water bath (3510 R-MTH, Branson Ultrasonics Corporation, Danbury, CT, USA) for 30 min before each analysis. The refractive index (RI) of the sample was set as 1.46 while distilled water was 1.33. 2.

### Filling Free Liquid Oil Volume Determination (%)

This determination allows the quantification of the free liquid oil percentage in a pre-defined volume of filling. Free liquid oil is the percentage of liquid oil which is not held (entrapped) by the crystal structure under the conditions studied.

Samples preparation: samples were packed into an x-ray lucent plastic pipette to decrease sample movement while scanning.

Method: X-ray Computed Micro Tomography (XRCMT). A non-destructive analysis which collects optical slices in 2D and is digitally reconstructed to form the structure in 3D. An NSI Imagix XRCMT system with Hamamatsu x-ray source was utilized for data acquisition. Images were obtained at 32 kv and 200 μA at 8.26 μm pixel resolution. Relative quantitative analysis performed by VSG Avizo Fire software.

### Example 1

### Examples of Powdered Fat:

| | | | Mean | Saturated |
|---|---|---|---|---|
| Powdered | Powdered fat | Density | particle | fat content |
| fat ID | composition | (g/ml) | size (μm) | (%) |
| B2 | 50% hydrogenated soybean | 0.121 | 38.8 | 57% |
| | fat + 50% soybean oil | | | |
| B5 | 67% hydrogenated soybean | 0.044 | 12.4 | 71% |
| | fat + 33% soybean oil | | | |
| B8 | 75% hydrogenated soybean | 0.056 | 15.4 | 78% |
| | fat + 25% soybean oil | | | |
| B11 | 33% hydrogenated soybean | 0.066 | 86.0 | 43% |
| | fat + 67% soybean oil | | | |

### Example 2

### Example of Biscuit Filing

### Procedure:

1. Weight the powdered fat.
2. Add sugar to the powdered fat. Apply shear at 100 rpm
3. Add oil and mix (shear at 100 rpm) to make a cream. (filling)

| | Low SAFA | Low SAFA | Low SAFA | Low SAFA |
|---|---|---|---|---|
| | Filling made | Filling made | Filling made | Filling made |
| Material or | with powdered | with powdered | with powdered | with powdered |
| property | fat B2 | fat B5 | fat B8 | fat B11 |
| Powdered fat (g) | 0.3 | 0.3 | 0.3 | 0.3 |
| Soybean oil (g) | 1.2 | 1.2 | 1.2 | 1.2 |
| Total Fat phase | 1.5 | 1.5 | 1.5 | 1.5 |
| (g) | | | | |
| (powdered fat + | | | | |
| liquid oil) | | | | |
| Total Sugar (g) | 3.5 | 3.5 | 3.5 | 3.5 |
| Filling physical | Firm filling | Firm filling | Firm filling | Firm, sticky |
| characteristic | | | | filling |
| Free liquid oil | 1.7% | 2.1% | 1.5% | 1.4% |
| volume in the | | | | |
| filling (%)* | | | | |
| Total fat phase | 30 | 30 | 30 | 30 |
| (powdered fat + | | | | |
| liquid oil) in the | | | | |
| filling (%) | | | | |
| Total SAFA in the | 23.4 | 26.2 | 27.6 | 20.6 |
| filling fat phase | | | | |
| (%) | | | | |
| Total SAFA in the | 7.02 | 7.86 | 8.28 | 6.18 |
| filling (%) | | | | |
| Reference: total | 10.5% to 16.5% | 10.5% to 16.5% | 10.5% to 16.5% | 10.5% to 16.5% |
| SAFA in the | | | | |
| filling if made | | | | |
| with conventional | | | | |
| fat** that contains | | | | |
| from 35-55% | | | | |
| SAFA | | | | |
| Reduction in | 33-57% | 25-52% | 21-50% | 41-62% |
| SAFA | | | | |

*For reference, a biscuit filling that contains 30% palm oil has a free liquid oil volume of 5.1%.
**examples of conventional fats that are used in fat fillings:
Palm oil 50% SAFA
Interesterified palm Olein 47% SAFA
Palm based fat 52% SAFA
Palm and Soy based fat 36% SAFA

1. A food product comprising a powdered fat that is consisting of 20 wt. % to about 100 wt. % of a hard fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure, and wherein the powdered fat is not derived from palm oil or palm kernel oil.

2. The food product according to claim 1, wherein the food product is baked goods, baked goods that are filled and/or topped and/or coated or with added inclusions, pie, bread, cake, donut, waffles, confectionery goods, confectionery filling, biscuits, dough product, filling, topping, coating, icing, frosting, cookie filling, biscuit filling, wafer filling, sandwich cookies, pie cookies, extruded cookies, thumbprint cookies, Hamentaschen cookies, whoopie cookies, linzer cookies, macarons, chocolate spread, nut butter, toffee, caramel, compound chocolate, compound coatings, ice-cream, microwaved popcorn, meat alternative, or milk or dairy fat replacer, pie crust, cake, pizza crust, cookie, biscuit, snacks, cereals, pasta, powdered food as powder instant soup, instant mashed potato, powder savory blends, powder cake mix, powder cheese bread, popcorn, crackers, savory bakery goods, bouillon.

3. The food product according to claim 1, wherein the food product is a biscuit filling, wafer filling, pie cookie filling, cracker filling or cookie filling.

4. The food product according to claim 1, wherein the food product is comprising a liquid oil or oil blends that are liquid at 20° C., at atmospheric pressure.

5. The food product according to claim 1, wherein the hard fraction of the powdered fat is derived from sunflower oil, corn oil, soybean oil, canola oil, rapeseed oil, cottonseed oil, rice bran oil, safflower oil, linseed oil, flaxseed oil, peanut oil, olive oil, tall oil, licuri oil, macadamia nut oil, its high oleic version its high stearic versions, shea butter, coconut oil, mango kernel oil, illipe oil, babassu oil, pequi oil, tallow, allanblackia oil, cocoa butter, nut oil, bacuri fat, cupuassu fat, ucuuba butter, macauba oil, macauba kernel oil, animal fat, dairy fat, and their fractions and their fully or partially hydrogenated and/or chemically or enzymatically interesterified versions, and combinations of two or more thereof.

6. The food product according to claim 1, wherein the liquid oil of the food product and/or the soft fraction of the powdered fat is derived from soybean oil, sunflower oil, rapeseed oil, canola oil, corn oil, cottonseed oil, rice bran oil, safflower oil, linseed oil, flaxseed oil, peanut oil, olive oil, tall oil, licuri oil, macadamia nut oil, its high oleic versions, its high stearic versions, its partially hydrogenated, chemically interesterified, enzymatically interesterified versions and combinations of two or more thereof.

7. The food product according to claim 1, wherein the powdered fat is having a density ranging from 0.04 to 0.7 g/ml.

8. The food product according to claim 1, wherein the powdered fat is having a particle size ranging from 0.01 to 200.0 μm.

9. The food product according to claim 1, wherein the food product is comprising at least one surface active material and/or emulsifier selected from the group consisting of propylene glycol esters, polyglycerol esters, lecithins, monoglycerides, diglycerides, polysorbates, lactic acid esters of monoglycerides, lactic acid esters of diglycerides, acetic acid esters of monoglycerides acetic acid esters of diglycerides, citric acid esters of monoglycerides, citric acid esters of diglycerides, sucrose esters of fatty acids, sorbitan esters, polyricinoleate and combinations of two or more thereof.

10. The food product according to claim 1, wherein the food product has a free liquid oil volume of less than 3%, measured with X-ray computed tomography, and free liquid oil volume is the percentage of liquid oil which is not held by the solid structure of the fat.

11. Use of a powdered fat that is consisting of 20 wt. % to about 100 wt. % of a hard fraction and up to 80 wt % of a soft fraction wherein the hard fraction is derived from fats or fat blends that are solid at 20° C., at atmospheric pressure and wherein the soft fraction is derived from oils or oil blends that are liquid at 20° C., at atmospheric pressure, and wherein the powdered fat is not derived from palm oil or palm kernel oil to reduce the saturated fatty acid content of a food product.

12. The use according to claim 11, wherein the food product is a biscuit filling, wafer filling, pie cookie filling, cracker filling or cookie filling.

13. The use according to claim 11, wherein the free liquid oil volume of the food product is less than 3%, measured with X-ray computed tomography and free liquid oil volume is the percentage of liquid oil which is not held by the solid structure of the fat.
